(19) United States
(12) Patent Application Publication
(10) Pub. No.: US 2006/0149006 A1
(43) Pub. Date: Jul. 6, 2006

(54) Method for producing copolymers and terpolymers from olefins

(76) Inventors: Katrin Koehler, Goettingen (DE); Walter Kaminsky, Pinneberg (DE); Andrea Esisenhardt, Hamburg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/539,513

(22) PCT Filed: Nov. 28, 2003
(86) PCT No.: PCT/EP03/13423

§ 371 Date: Jun. 17, 2005

(51) Int. Cl. C08F 4/44

(52) U.S. Cl. 526/124.3; 526/282; 526/901; 526/348.5; 526/348.6; 526/335; 526/348.2; 526/348.3; 526/129

(57) ABSTRACT

The present invention relates to a process for the preparation of co- and terpolymers from olefins having improved properties. In particular, the invention relates to the preparation of ethylene-propene copolymers (EPR), ethylene-propylene-diene terpolymers (EPDM) and further copolymers of ethylene-propene, 1-olefins and dienes having elastomeric properties which are improved by their structural makeup. In particular, this is a process for the preparation of EPR and EPDM rubbers by polymerisation of ethylene and propene, optionally ethylidenenorborne as diene at temperatures between −20 to 150° C. by means of a titanium-containing mixed catalyst and donor-stabilised aluminium compounds

The present invention relates to a process for the preparation of co- and terpolymers from olefins having improved properties. In particular, the invention relates to the preparation of ethylene-propene co-polymers (EPR), ethylene-propylene-diene terpolymers (EPDM) and further copolymers of ethylene-propene, 1-olefins and dienes having elastomeric properties which are improved by their structural makeup. In particular, this is a process for the preparation of EPR and EPDM rubbers by polymerisation of ethylene and propene, optionally ethylidenenorbornene as diene at temperatures between −20 to 150° C. by means of a titanium-containing mixed catalyst and donor-stabilised aluminium compounds.

### PRIOR ART AND OBJECT OF THE INVENTION

For the preparation of EPR and EPDM, use has hitherto been made of either supported catalysts based on titanium compounds or soluble systems based on vanadium or metallocene catalysts (Seppälä et al. [EU1994], Eur. Polym. J. 30, 1111). The rubbers produced in this way are used, for example, in tyres, hoses, roof membranes, cable sheaths, seals, and to this end are provided with fillers, stabilisers, antioxidants, oils, lubricants, vulcanisation assistants or sulfur. The supported catalysts are prepared either by mixing magnesium halide, one or more electron donors (internal or external) and titanium trichloride or from microcrystalline titanium trichloride, with alkylaluminium compounds serving as activator. Such catalysts are described, for example, by Govoni and Galli (1997), U.S. Pat. No. 5,698,642 and by Kashiwa et al. (2984), Polym. Bull. 12, 362. A disadvantage of these catalyst systems consists in that crystalline ethylene sequences can be formed which reduce the elasticity of the material (Kakugo et al. (1989) Makromol. Ch. 190, 849). Furthermore, the diene component necessary for EPDM elastomers can only be incorporated with difficulty and with considerable costs. Preferred catalyst systems in the process for the preparation of these polymers in industry are therefore soluble vanadium complexes. However, this is very complex since solvents and toxic catalyst residues have to be removed after the polymerisation. Furthermore, suitable particle morphologies for further processing are not obtained on work-up. Syntheses in the gas phase are therefore recently also being carried out, as described in U.S. Pat. No. 4,508,842. However, the catalysts employed for this purpose do not have satisfactory heat stability. At the desirable elevated polymerisation temperature of 50 to 95° C., the service life of the catalyst systems is short, causing the productivity to drop. At the same time, the dienes in the case of EPDM elastomers are not incorporated with a uniform distribution over the polymer chain, but instead are concentrated in short polymer chains or at the ends. The catalyst described in this US patent is obtained by reaction of vanadium trichloride, an electron donor, assistants and silicon dioxide supports. Although the particle morphology is better than in the titanium systems, blocks of isotactically linked propene units are, however, also present here. This results in undesired high-temperature crystallinity.

### OBJECTIVE AND SUBJECT-MATTER OF THE INVENTION

The present invention is therefore based on the object of providing a process for the preparation of co- and terpolymers which gives the desired polymers, which, however, do not have the enumerated disadvantages. A further object consists in providing catalyst systems which can be employed in this process and which have high heat stability together with high activity in the co- and terpolymerisation of olefins, can be prepared in a simple and inexpensive manner and give co- and terpolymers having industrially interesting properties. The catalyst systems according to the invention should be suitable for use in large-scale industrial plants under simple conditions.

The object is achieved by a process as characterised by claims 1 to 14 and by co- and terpolymers obtainable by the process according to the invention.

### DESCRIPTION OF THE INVENTION

Experiments have now shown that the disadvantages indicated can be overcome if compounds of the general formula (I) 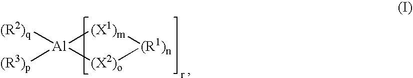
in which
X¹ denotes NR, PR, O or S, optionally complex-bonded to aluminium
X² denotes NRR′, PRR′, OR, SR, complex-bonded to aluminium
R¹ denotes linear or branched alkylene, cycloalkylidene, alkenylene, arylene, silylene, all of which may contain hetero atoms, such as N, P, O, S, F or X¹ or X², optionally complex-bonded to aluminium
R², R³, independently of one another, denote linear or branched alkyl, cycloalkyl, alkenyl, aryl, alkynyl, silyl, H, F, Cl, Br, I or X², each of which may itself be partially fluorinated or perfluorinated
R, R′, independently of one another, denote linear or branched alkyl, cycloalkyl, alkenyl, aryl, alkynyl, silyl or H, each of which may itself be partially fluorinated or perfluorinated
m denotes 0, 1
n denotes 1, 2, 3, 4, 5, 6, 7; if n>1, R¹ may, independently of one another, adopt different meanings
o denotes 0, 1
p, q denote 0, 1, 2
r denotes 3-p-q,
   are employed as components in coordination catalysts for the co- and terpolymerisation of olefins in an adapted process.

The coordination catalyst itself consists of
(A) an intramolecularly Lewis base-stabilised organoaluminium compound of the general formula (I),
(B) a titanium- or vanadium-containing mixed catalyst
(C) optionally also of a support based on MgCl₂, SiO₂ or SiO₂ in combination with MgCl₂.

The compounds of the general formula (I) have the function of the co-catalyst in the coordination catalyst system, i.e. they convert the catalyst into the catalytically active species and thus have a major influence on the activity and productivity of the catalyst system.

The intramolecularly present donor group in the compounds of the general formula (I) enables these compounds also to have stereo-selectivity-promoting properties in addition to the cocatalytic properties.

Earlier patents reported on the use of donor atom-stabilised organo-aluminium compounds in the homopolymerisation of ethylene (EP0919557, EP1132409, DE10128299) and propylene (DE10149785). Surprisingly, it has now been found that these compounds of the general formula (I) prove to be particularly suitable as cocatalysts in co- and terpolymerisations since they have higher activities and higher comonomer incorporation in the co- and terpolymer compared with the triethylaluminium usually used. The desired polymers can advantageously be prepared using significantly smaller amounts of the catalyst system according to the invention than on use of conventional catalyst systems. The expensive co-monomers can also be added in a smaller excess. The use of these cocatalysts in polymerisation reactions also enables completely new co- and terpolymer fractions to be prepared compared with the prior art. The properties of the resultant co- and terpolymers are in industrially interesting ranges.

Compounds of the general formula (I) can be prepared by methods known to the person skilled in the art for the preparation of organo-metallic compounds. Processes for the preparation of such compounds are described, for example, in G. Bähr, P. Burba, Methoden der organischen Chemie [Methods of Organic Chemistry], Vol. XIII/4, Georg Thieme Verlag, Stuttgart (1970), Z. Anorg. Allg. Chem. 2000, 626, 2081, DE10128299 or in DE10149785. The cited documents thus count amongst the disclosure content of the present invention.

The compounds of the general formula (I) are fairly stable to oxygen, in particular the oxygen in air, and to the influence of moisture. They have decidedly high heat stability. This also applies to the coordination catalysts prepared with the aid of these compounds. Furthermore, corresponding coordination catalyst systems have particularly high stability under the reaction conditions. They have a significantly lower tendency to deactivation by compounds having free electron pairs, in particular compounds containing hetero atoms, such as sulfur, oxygen, nitrogen or phosphorus. They also have a higher tolerance to polyunsaturated compounds/comonomers, such as, for example, dienes. The catalyst systems according to the invention have very particularly advantageous properties in co- and terpolymerisation reactions of olefins.

### DETAILED DESCRIPTION OF THE INVENTION

In the general formula (I), linear or branched alkyl is taken to mean linear or branched carbon chains having 1 to 20 C atoms. These are, for example, methyl, ethyl, i- and n-propyl groups and, as further groups, these are taken to mean in each case the branched and unbranched isomers of butyl, pentyl, hexyl, heptyl, octyl, etc., up to C₂₀.

Cycloalkyl groups are taken to mean, for example, cyclopentyl, cyclohexyl or cycloheptyl groups.

Alkenyl groups in turn are linear or branched carbon chains having 2 to 10 C atoms, such as, for example, vinyl, allyl or the isomeric butenyl groups. However, these are taken to mean not only the mono-unsaturated, but also polyunsaturated groups, such as, for example, pentadienyl.

Aryl groups can be, for example, phenyl or naphthyl, indenyl, and other fused aromatic groups.

Alkynyl groups are linear or branched carbon chains having 2 to 10 C atoms, such as ethynyl, propynyl, butynyl, etc., up to C₁₀ or the corresponding isomeric representatives.

Silyl groups can be, for example, (CH₃)₃Si, (C₂H₅)₃Si, (C₃H₇)₃Si or (C₆H₅)₃Si.

Furthermore, linear or branched alkylene in the general formula (I) is taken to mean linear or branched carbon chains having 1 to 20 C atoms. These are taken to mean, for example, methylene, ethylene groups and, as further groups, in each case the branched and unbranched isomers of propylene, butylene, pentylene, hexylene heptylene, octylene, etc., up to C₂₀.

Cycloalkylidene groups are taken to mean, for example, cyclopentylidene, cyclohexylidene or cycloheptylidene groups.

Alkenylene groups in turn are linear or branched carbon chains having 2 to 10 C atoms, such as, for example, vinylene, allylene or the isomeric butenylene groups. However, these are taken to mean not only the monounsaturated, but also polyunsaturated groups, such as, for example, pentadienylene.

Arylene groups can be, for example, phenylene or naphthylene, indenylene, and other fused aromatic groups.

Silylene groups can be, for example, (CH₃)₂Si, (C₂H₅)₂Si, (C₃H₇)₂Si or (C₆H₅)₂Si.

In particular, the object on which the invention is based is achieved by the use of compounds of the general formula (I) as cocatalysts, in which
X¹ is absent,
X² stands for NRR′ or OR, complex-bonded to aluminium,
R¹ stands for linear or branched C₂-C₁₀-alkylene, C₂-C₁₀-alkenylene, C₆-C₁₀-arylene or silylene,
R², R³ stands for linear or branched C₁-C₁₀-alkyl,
R, R′ stands for linear or branched C₁-C₁₀-alkyl, C₆-C₁₀-aryl or silyl,
m is 0,
n is 2, 3, 4, 5, 6, 7,
o is 1
p, q is 1 and
r is 1.
   From this group of compounds, compounds of the general formula (I) in which
R′ stands for linear or branched C₃-C₅-alkylene, C₃-C₅-alkenylene or C₆-C₁₀-arylene,
R², R³ stands for linear or branched C₁-C₄-alkyl and
n is 1, 2, 3, 4,
   have in turn proven particularly suitable for use as catalyst component in co- and terpolymerisations of olefins.

In particular, the object according to the invention is therefore achieved by corresponding catalyst systems which comprise an organoaluminium compounds of the general formula (I) selected from the group

[3-(dimethylamino)propyl]dimethylaluminium,

[3-(dimethylamino)propyl]diethylaluminium,

[3-(dimethylamino)propyl]dibutylaluminium,

[3-(diethylamino)propyl]dimethylaluminium,

[3-(diethylamino)propyl]diethylaluminium,

[3-(diethylamino)propyl]dibutylaluminium,

[4-(dimethylamino)butyl]dimethylaluminium

[4-(dimethylamino)butyl]diethylaluminium

[4-(dimethylamino)butyl]dibutylaluminium.

[4-(diethylamino)butyl]dimethylaluminium

[4-(diethylamino)butyl]diethylaluminium

[4-(diethylamino)butyl]dibutylaluminium

[2-(dimethylamino)phen-1-yl]dimethylaluminium,

[2-(dimethylamino)phen-1-yl]diethylaluminium,

[2-(dimethylamino)phen-1-yl]dibutylaluminium,

[2-(diethylamino)phen-1-yl]dimethylaluminium,

[2-(diethylamino)phen-1-yl]diethylaluminium,

[2-(diethylamino)phen-1-yl]dibutylaluminium,

[2-(dimethylamino)benzyl]dimethylaluminium,

[2-(dimethylamino)benzyl]diethylaluminium,

[2-(dimethylamino)benzyl]dibutylaluminium,

[2-(diethylamino)benzyl]dimethylaluminium,

[2-(diethylamino)benzyl]diethylaluminium,

[2-(diethylamino)benzyl]dibutylaluminium,

[2-(dimethylaminomethyl)phen-1-yl]dimethylaluminium,

[2-(dimethylaminomethyl)phen-1-yl]diethylaluminium,

[2-(dimethylaminomethyl)phen-1-yl]dibutylaluminium,

[2-(diethylaminomethyl)phen-1-yl]dimethylaluminium,

[2-(diethylaminomethyl)phen-1-yl]diethylaluminium,

[2-(diethylaminomethyl)phen-1-yl]dibutylaluminium,

[8-(dimethylamino)naphth-1-yl]dimethylaluminium,

[8-(dimethylamino)naphth-1-yl]diethylaluminium,

[8-(dimethylamino)naphth-1-yl]dibutylaluminium,

[3-(methoxy)propyl]dimethylaluminium,

[3-(methoxy)propyl]diethylaluminium,

[3-(methoxy)propyl]dibutylaluminium,

[3-(ethoxy)propyl]dimethylaluminium,

[3-(ethoxy)propyl]diethylaluminium,

[3-(ethoxy)propyl]dibutylaluminium,

[3-(butoxy)propyl]dimethylaluminium,

[3-(butoxy)propyl]diethylaluminium,

[3-(butoxy)propyl]dibutylaluminium,

[2-(methoxy)phen-1-yl]dimethylaluminium,

[2-(methoxy)phen-1-yl]diethylaluminium,

[2-(methoxy)phen-1-yl]dibutylaluminium,

[2-(methoxy)benzyl]dimethylaluminium,

[2-(methoxy)benzyl]diethylaluminium,

[2-(methoxy)benzyl]dibutylaluminium,

[2-(methoxymethyl)phen-1-yl]dimethylaluminium,

[2-(methoxymethyl)phen-1-yl]diethylaluminium,

[2-(methoxymethyl)phen-1-yl]dibutylaluminium,

[8-(methoxy)naphth-1-yl]dimethylaluminium,

[8-(methoxy)naphth-1-yl]diethylaluminium,

[8-(methoxy)naphth-1-yl]dibutylaluminium,

[8-(ethoxy)naphth-1-yl]dimethylaluminium,

[8-(ethoxy)naphth-1-yl]diethylaluminium,

[8-(ethoxy)naphth-1-yl]dibutylaluminium.

Experiments have shown that, in particular,

[2-(methoxy)benzyl]dibutylaluminium,

[3-(dimethylamino)propyl]dimethylaluminium,

[3-(dimethylamino)propyl]diethylaluminium and

[2-(diethylaminomethyl)phen-1-yl]diethylaluminium are suitable as components in these coordination catalysts for the co-polymerisation of olefins.

The experiments have shown here that, in particular,

[3-(dimethylamino)propyl]diethylaluminium and

[2-(diethylaminomethyl)phen-1-yl]diethylaluminium are suitable as cocatalysts for the copolymerisation of ethene with propene and

[3-(dimethylamino)propyl]dimethylaluminium is suitable for the copolymerisation of ethene with hexene.

Experiments have furthermore shown that, in particular, [2-(diethylaminomethyl)phen-1-yl]diethylaluminium is suitable as component in coordination catalysts for the terpolymerisation of ethylene, propylene and ethylidenenorbornene.

The present invention therefore also relates to the use of a catalyst system of this type in polymerisation reactions of olefins. Suitable olefinically unsaturated hydrocarbons are, for example, ethylene, C₃- to C₁₂-alk-1-enes, such as propene, 1-butene, isobutene, 1-pentene, 4-methyl-1-pentene, 1-hexene, 1-heptene, 1-octene, 1-nonene, 1-decene, 1-undecene, 1-dodecene, furthermore styrene, α-methyl-styrene, cycloolefins, such as cyclopentene, norbornene, or, however, dienes, such as 1,3-butadiene, 1,4-hexadiene, ethylidenenorbornene or norbornadiene. Preference is given to the use of ethylene, propylene, 1-butene, 1-hexene, 1-octene, norbornene, butadiene or ethylidenenorbornene.

As already stated above, the compounds of the general formula (I) are very stable compounds with the aid of which likewise very stable coordination catalyst systems are advantageously obtained, making the preparation, storage and use thereof significantly less problematic than in the case of systems known to date. In particular, the complex complete exclusion of oxygen, air and moisture in the solvents, monomers and protective gases employed in the co- and terpolymerisations is unnecessary.

The catalysts are prepared and used in a manner known per se, as is usual for the respective system and the respective use. To this end, the catalyst, supported or unsupported depending on the process, is dissolved or suspended in a solvent, for example in a hydrocarbon, such as pentane, hexane, heptane, octane or toluene. The reaction is controlled and the reaction products isolated and worked up likewise in an entirely analogous manner.

As already mentioned, the increased stability of the donor-stabilised organoaluminium compounds and the considerably reduced sensitivity of the resultant catalyst compounds mean that all process steps are essentially problem-free and can be carried out under significantly less strict protective and safety measures. This therefore enables the said polymerisation reactions to be prepared under significantly less expensive conditions.

The use of the catalyst systems according to the invention having advantageous properties, such as, for example, higher activities and productivities compared with the prior art makes novel polymers having novel or even considerably improved properties available in accordance with the present invention by co- or terpolymerisation of olefins. Depending on the application requirements, it is possible to select cocatalysts which are customised for the particular polymerisation

In the copolymerisation of ethene and propene, up to 6-fold higher activities and up to 20% higher incorporation rates of propene in the ethylene-propene copolymer compared with the prior art with AlEt₃ are already found on use of the compounds of the general formula (I), even at 30° C. The highest incorporation rate of propene in the ethene-propene copolymer achieved with the compounds of the general formula (I) is 50%, that with AlEt₃ is 37%. The copolymer molecular weights achieved are in the range from 1 10,000 to 1,200,000 g/mol. By comparison, molecular weights of between 50,000 and 1,100,000 g/mol have been found with AlEt₃ as cocatalyst.

With variation of the molar ratio of the monomers and the process conditions, it is also possible to obtain copolymers of this type having lower or higher incorporation rates and thus to prepare polymers having properties which cover a broader range of properties. Under suitable conditions, it is possible to prepare ethylene-propene co-polymers having molecular weights in the range from 50,000 to 1,500,000 g/mol in which the molar ethylene-propene ratio is in the range from 1:99 to 99:1.

In the terpolymerisation of ethene, propene and ethylidenenorbornene, up to 2-fold higher activities compared with the prior art with AlEt₃ have arisen on use of the compounds of the general formula (I) in experiments carried out. In a batch of ethylene/propylene/ethylidenenorbornene in the ratio of 30/60/10, a terpolymer having the industrially interesting composition of x_{ethylene}:0.75, x_{propylene}:0.2, x_{ethylidenenorbornene}:0.05 mol- % was found which has a molecular weight of 100.000 g/mol and a glass transition temperature of T_{g}=−53° C., and meets industrial requirements extremely well. It has to date not been possible to prepare this terpolymer in accordance with the prior art with (AlEt₃) as cocatalyst. The compounds of the general formula (I) have great tolerance to dienes compared with AlEt₃. The mere presence of ethylidenenorbornene (ENB) in the olefin monomer starting solution (ethylene, propylene, ENB) results, on use of AlEt₃, not only in a drop in the activity and non-incorporation of ENB, but also in propene hardly being incorporated into the polymer chain at all, although propene is definitely incorporated into the polymer chain in the ethene-propene copolymerisation.

Suitable variation of the process conditions enables the preparation of ethylene-propene-ethylidenenorbornene terpolymers having an ethylene/propene/ethylidenenorbornene ratio in the range x_{ethylene}: 0.5-0.9, x_{propylene}:0.05-0.3, x_{ethylidenenorbornene}:0.05-0.2 mol, and a molecular weight in the range from 50,000 to 1,000,000 g/mol.

Surprisingly, it has been found that the type of hetero atom in the Lewis base-stabilised organoaluminium compounds can have a considerable effect on the properties of the co- and terpolymers.

The polymerisation processes in the presence of the cocatalysts according to the invention for the preparation of the copolymers are not restricted to a defined method. Conditions can advantageously be selected as on use of a Ziegler-Natta catalyst system or a Kaminsky catalyst system.

For example, mass or bulk polymerisations in which monomers are used as solvent, solution polymerisations in a suitable solvent, suspension polymerisations in a suitable inactive solvent and gas-phase polymerisations under the influence of a suitable pressure can advantageously be carried out in the presence of the compounds of the general formula (I) according to the invention as components of a catalyst system so long as the copolymers or terpolymers prepared have the desired properties. The polymers can be prepared either batchwise or continuously. Although this does not completely change the constitution of the polymers, it is, however, necessary to monitor certain parameters in a suitable manner in any polymerisation process and to optimise them through the choice of a suitable cocatalyst system according to the invention. The choice of the concentrations of the monomers to be polymerised, mixing by suitable measures, the set reaction temperatures, separation methods and the like also play a role and can be optimised.

Particularly good polymerisation results have been achieved with the cocatalyst systems according to the invention in solution polymerisations. Accordingly, examples of this polymerisation process, which is also the subject-matter of the present invention, are given below.

In order to carry out the process, the individual components (A), (B) and (C) can be combined in advance to give a catalyst system which can be employed directly. For example, the components can be mixed with one another in advance in a suitable manner and subsequently employed for the polymerisation. However, they can also first be mixed with one another in the polymerisation mixture. If necessary, the catalyst components can be applied to a support based on MgCl₂, SiO₂ or SiO₂ in combination with MgCl₂. Solvents which can be used for the combination of the catalyst components are, inter alia, inert hydrocarbons, such as propane, butane, pentane, hexane, octane, decane, cyclic hydrocarbons, such as cyclopentane, cyclohexane, methylcyclopentane, aromatic hydrocarbons, such as benzene, toluene and xylene, halogenated hydrocarbons, such as ethylene chloride, chlorobenzene and dichloromethane, or mixtures thereof. Temperature, pressure, gas atmosphere and duration are selected in a known manner during the preparation process. It goes without saying that low temperatures make a longer reaction duration necessary. However, an excessively high temperature can reduce the achievable activity of the catalyst system. The catalyst system is preferably prepared at a temperature at which the polymerisation reaction also takes place.

The co- and terpolymerisations according to the invention are preferably carried out at temperatures in a range from −20 to 120° C., preferably in a range of 0-100° C.

Even on use of the cocatalyst systems according to the invention for solution polymerisation, the person skilled in the art is not restricted per se in the choice of a suitable solvent so long as the solvents behave inertly in the polymerisation. Suitable solvents are, for example, aromatic hydrocarbons, such as benzene, toluene, xylene or ethylbenzene, or cyclic hydrocarbons, such as cyclopentane, methylcyclohexane, or aliphatic hydrocarbons, such as pentane, hexane, heptane, octane, or halogenated hydrocarbons, such as chloroform, dichloromethane, or mixtures thereof. It is also possible to employ a monomer as solvent and in excess so that it serves as solvent so long as the composition of the desired copolymer is not adversely affected thereby.

In order to prepare a terpolymer having the desired properties in accordance with the present invention, the setting of the polymerisation temperature during the reaction is very important in addition to the choice of an optimally suitable cocatalyst system. In accordance with the present invention, it is possible for the person skilled in the art to determine the optimum temperature range for the preparation of a co- or terpolymer having the desired properties by various methods known to him. In particular, this is possible for him through creation of a parameter matrix into which all reaction parameters are entered, with the aid of which an experiment plan is developed.

In accordance with the invention, the polymerisation temperatures are generally in a range from −20 to 120° C., preferably in a range of 0-100° C. Co- and terpolymers having particularly good properties are obtained by solution polymerisation, in particular at temperatures of 20 to 100° C. Very particularly good results are achieved at temperatures of 30-100° C.

If the temperature is kept too low, the catalyst activity drops, so that the polymerisation reaction is terminated. If, by contrast, the temperature is set too high, the catalyst activity may drop, which may be attributable to decomposition. On the other hand, undesired side reactions may also occur in this case, or termination of the polymerisation reaction may likewise occur. Accordingly, the polymerisation temperature should be selected by the person skilled in the art in such a way that a high catalyst activity is guaranteed, ensuring the highest possible reaction rate throughout the reaction time and giving a co- or terpolymer having the desired properties, i.e. having the corresponding comonomer incorporation rates, a sufficiently high molecular weight at the same time as low crystallinity and having improved processing properties.

It is possible for the person skilled in the art to follow the course of the polymerisation reaction by various analytical methods. For example, it is possible to monitor the composition of the reaction mixture by a wide variety of spectroscopic methods, such as, for example, by IR, NMR, etc., by continuous sampling or to measure directly the amounts of monomer consumed during the polymerisation.

The reaction product can be separated off in accordance with the present invention by methods known to the person skilled in the art. These methods include simple removal of the solvent by distillation and steam distillation for removal of the solvent or the addition of methanol for precipitation; however, other methods are also suitable. The product can be separated off, collected and dried.

It has been found that 30-90% by weight of ethylene have been incorporated into ethylene copolymers which have been prepared by the process according to the invention. These polymers have a glass transition temperature of less than −30° C., preferably lower than −40° C. In addition, the polymers according to the invention prepared by the experiments have densities of less than 0.89 g/cm³. Furthermore, the co- and terpolymers according to the invention have, at a temperature of 70° C., viscosities which are extraordinarily favourable for processing, even at molecular weights M_{w} of higher than 100,000 g/mol. In any case, they are lower than η=8.0 dl/g, but higher than η=1.0 dlI/g.

As revealed by the above-described, monitoring of the molecular weight of the polymer product prepared is one of the important characteristics. This can be crucially influenced by the choice of the catalyst system, by the molar ratio employed of the monomers employed to one another, the polymerisation temperature, but also greatly by the pressure during the polymerisation reaction, so that polymers having very different average molecular weights can be prepared by the process according to the invention. Experiments have shown that, in particular in the choice of the cocatalyst system, component (A) has a crucial influence both on the molecular weight and also on the composition of the resultant polymer.

In this connection, it has been found that the use of compounds of the general formula (I) as component (A) in the cocatalyst systems according to the invention selected from the group

[3-(dimethylamino)propyl]dimethylaluminium,

[3-(dimethylamino)propyl]diethylaluminium,

[3-(dimethylamino)propyl]dibutylaluminium,

[3-(diethylamino)propyl]dimethylaluminium,

[3-(diethylamino)propyl]diethylaluminium,

[3-(diethylamino)propyl]dibutylaluminium,

[4-(dimethylamino)butyl]dimethylaluminium

[4-(dimethylamino)butyl]diethylaluminium

[4-(dimethylamino)butyl]dibutylaluminium

[4-(diethylamino)butyl]dimethylaluminium

[4-(diethylamino)butyl]diethylaluminium

[4-(diethylamino)butyl]dibutylaluminium

[2-(dimethylamino)phen-1-yl]dimethylaluminium,

[2-(dimethylamino)phen-1-yl]diethylaluminium,

[2-(dimethylamino)phen-1-yl]dibutylaluminium,

[2-(diethylamino)phen-1-yl]dimethylaluminium,

[2-(diethylamino)phen-1-yl]diethylaluminium,

[2-(diethylamino)phen-1-yl]dibutylaluminium,

[2-(dimethylamino)benzyl]dimethylaluminium,

[2-(dimethylamino)benzyl]diethylaluminium,

[2-(dimethylamino)benzyl]dibutylaluminium,

[2-(diethylamino)benzyl]dimethylaluminium,

[2-(diethylamino)benzyl]diethylaluminium,

[2-(diethylamino)benzyl]dibutylaluminium,

[2-(dimethylaminomethyl)phen-1-yl]dimethylaluminium,

[2-(dimethylaminomethyl)phen-1-yl]diethylaluminium,

[2-(dimethylaminomethyl)phen-1-yl]dibutylaluminium,

[2-(diethylaminomethyl)phen-1-yl]dimethylaluminium,

[2-(diethylaminomethyl)phen-1-yl]diethylaluminium,

[2-(diethylaminomethyl)phen-1-yl]dibutylaluminium,

[8-(dimethylamino)naphth-1-yl]dimethylaluminium,

[8-(dimethylamino)naphth-1-yl]diethylaluminium,

[8-(dimethylamino)naphth-1-yl]dibutylaluminium,

[3-(methoxy)propyl]dimethylaluminium,

[3-(methoxy)propyl]diethylaluminium,

[3-(methoxy)propyl]dibutylaluminium,

[3-(ethoxy)propyl]dimethylaluminium,

[3-(ethoxy)propyl]diethylaluminium,

[3-(ethoxy)propyl]dibutylaluminium,

[3-(butoxy)propyl]dimethylaluminium,

[3-(butoxy)propyl]diethylaluminium,

[3-(butoxy)propyl]dibutylaluminium,

[2-(methoxy)phen-1-yl]dimethylaluminium,

[2-(methoxy)phen-1-yl]diethylaluminium,

[2-(methoxy)phen-1-yl]dibutylaluminium,

[2-(methoxy)benzyl]dimethylaluminium,

[2-(methoxy)benzyl]diethylaluminium,

[2-(methoxy)benzyl]dibutyl aluminium,

[2-(methoxymethyl)phen-1-yl]dimethylaluminium,

[2-(methoxymethyl)phen-1-yl]diethylaluminium,

[2-(methoxymethyl)phen-1-yl]dibutylaluminium,

[8-(methoxy)naphth-1-yl]dimethylaluminium,

[8-(methoxy)naphth-1-yl]diethylaluminium,

[8-(ethoxy)naphth-1-yl]dimethylaluminium,

[8-(ethoxy)naphth-1-yl]diethylaluminium,

[8-(ethoxy)naphth-1-yl]diethylaluminium,

[8-(ethoxy)naphth-1-yl]dibutylaluminium

result in co- or terpolymers having particularly favourable properties.

Of these, the compounds selected from the group

[2-(methoxy)benzyl]dibutylaluminium,

[3-(dimethylamino)propyl]dimethylaluminium,

[3-(dimethylamino)propyl]diethylaluminium and

[2-(diethylaminomethyl)phen-1-yl]diethylaluminium have in turn proven particularly suitable as components in coordination catalysts for the copolymerisation of olefins. In particular,

[2-(methoxy)benzyl]dibutylaluminium,

[3- (dimethylamino)propyl]dimethylaluminium and

[2-(diethylaminomethyl)phen-1-yl]diethylaluminium result in increased incorporation of propene in the polymer molecule in polymerisation reactions. A corresponding effect is effected in the copolymerisation of ethene and hexene by [2-(diethylaminomethyl)phen-1-yl]diethylaluminium.

For the terpolymerisation of ethylene, propylene and ethylidenenorbornene,

[2-(diethylaminomethyl)phen-1-yl]diethylaluminium has proven particularly suitable as component (A) in the coordination catalysts according to the invention. Surprisingly, the use of a catalyst system of this type has enabled terpolymers to be obtained which could not be prepared using catalyst systems known hitherto.

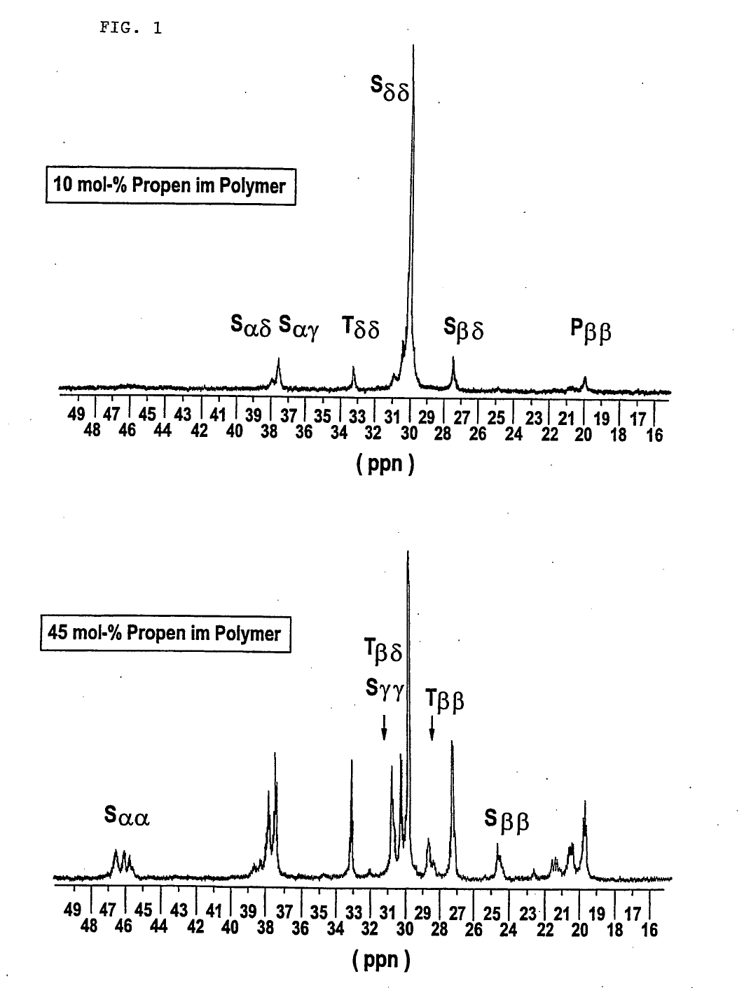

The tables shown in Example FIGS. 1-3 show the results of selected co- and terpolymerisation experiments.

The propene and ENB incorporation rates, determined by ¹³C-NMR spectroscopy, which have been achieved in a selected co- or terpolymerisation batch depending on the alkylaluminium compound used in combination with titanium tetrachloride supported on magnesium dichloride are shown. The polymerisations here were carried out as already described above under “Performance of the co- and terpolymerisation” and “Polymerisation condition”.

During performance of the polymerisations, two different polymer fractions were obtained, which can be separated from one another by further work-up and can be analysed separately. As also shown in the figures, two different sets of data are therefore obtained in most cases for one polymerisation batch.

The figures furthermore show the thermal properties of the polymers in the form of melting points or glass transition temperatures. In the case of the polymers having particularly interesting compositions, the molecular weight is additionally shown in order to make it clear that the polymer characteristics meet industrial requirements.

In order to be able to compare the various alkylaluminium compounds with regard to productivity, the values of the polymerisation activities achieved are shown comparatively in the figures.

The results shown in the figures were achieved under the following conditions:

Ethene/propene copolymerisation at Tₚ=30° C., E/P=0.4/0.6

| | | |
|---|---|---|
| Total monomer concentration: | 2 | mol/l |
| TiCl₄/MgCl₂ concentration: | 5 · 10⁻⁵ | mol |
| Alkylaluminium concentration: | 5 · 10⁻⁴ | mol |
| Al/Ti ratio: | 10 | |
| Polymerisation time: | 60 | min |

Ethene/propene copolymerisation at Tₚ=60° C.

| | | |
|---|---|---|
| Total monomer concentration: | 1 | mol/l |
| TiCl₄MgCl₂ concentration: | 1.25-2.5 · 10⁻⁵ | mol |
| Alkylaluminium concentration: | 1.25-2.5 · 10⁻⁴ | mol |
| Al/Ti ratio: | 10 | |
| Polymerisation time: | 60 | min |

Ethene/propene/ENB terpolymerisation at Tₚ=60° C., E/PIENB=0.310.6/0.1

| | | |
|---|---|---|
| Total monomer concentration: | 0.6 | mol/l |
| TiCl₄/MgCl₂ concentration: | 2.5 · 10⁻⁵ | mol |
| Alkylaluminium concentration: | 2.5 · 10⁻⁴ | mol |
| Al/Ti ratio: | 10 | |
| Polymerisation time: | 60 | min |

For better understanding and in order to illustrate the invention, examples are given below which are within the scope of protection of the present invention. However, owing to the general validity of the inventive principle described, these are not suitable for reducing the scope of protection of the present application to these examples alone.

### EXAMPLES

Performance of the co- and terpolymerisation

The polymerisations were carried out semi-continuously in a 1 l glass autoclave from Büchi. Firstly, the apparatus was tested for leaks, it being required for an introduced argon pressure of 4 bar to remain constant for a number of minutes. The reactor was then heated under an oil-pump vacuum for one hour, during which it was brought to a temperature of 95° C. The reactor was subsequently brought to the desired polymerisation temperature and then charged. The temperature was maintained during the reaction with an accuracy of ±10° C. For the solution polymerisations, firstly the selected amounts of toluene (400 ml) and TiCl₄/MgCl₂ suspension were initially introduced in a counterstream of argon, and, if appropriate, the amount of liquid monomer (ENB) necessary in each case was then added. The reaction solution was subsequently saturated firstly with propene and then with ethene. When the saturation was complete, the polymerisation was initiated by injection of the alkylaluminium solution by means of a Hamilton syringe. During the reaction, ethene was topped up so that the total pressure during the reaction remained constant. Since the monomer composition of the batch changes continuously in the case of the co- and terpolymerisations, the reactions were terminated sufficiently early that the conversion of the components which were not topped up in each case did not exceed 5-10%. The reaction was terminated by destroying the catalyst by injection of 5 ml of ethanol saturated with 2,6-di-^{tert}butyl-p-cresol for stabilisation of the double bonds in the polymer. The gaseous monomers were carefully released into the fume hood. In the case of the ethene/propene homo- and copolymerisations, the reactions were terminated by addition of ethanol. For the polymerisations in which the kinetic profile of the reaction was to be determined, the course of the topping-up of ethene was recorded with the aid of an RS232 4-channel flow computer from Westphal Mess- und Regeltechnik and a 5850 TR mass flow controller from Brooks.

Co- and terpolymer work-up

Toluene-Insoluble Polymers

The toluene-insoluble polymers were removed from the reactor and stirred overnight in about 300 ml of a wash solution comprising demineralised water, ethanol and concentrated hydrochloric acid (7:2:1). The mixture was subsequently filtered, and the polymers were washed until neutral firstly with a semisaturated sodium hydrogen-carbonate solution and then repeatedly with demineralised water. The polymer was then dried to constant weight at 60° C. in an oil-pump vacuum.

Toluene-Soluble Polymers

The toluene-soluble polymers were removed from the reactor and likewise stirred overnight with the above-mentioned wash solution. The toluene phase was separated off, neutralised using sodium hydrogencarbonate solution and washed three times with demineralised water. The toluene and any residues of liquid monomer were removed with the aid of a rotary evaporator. The drying was finally also carried out here at 40-60° C. in an oil-pump vacuum.

Polymerisation Conditions

Solvent: toluene

TiCl₄/MgCl₂ suspension: 0.05 M in toluene.(c_{cat}=2.5·10⁻⁵ mol−5·10⁻⁵ mol)

Organoaluminium compound: solutions in toluene (0.25 M)

Tₚ=30 or 60° C.

Al/Ti ratio=10 or 20

Results of experiments carried out are shown in FIGS. 1 to 3.

### Example 1

### Ethene/propene copolymerisation

Tₚ=30° C., ethene/propene=0.4/0.6.

Activity in [kg/(mol_{Ti}*h*mol/l)].

| | | | mol | | | Ac- |
|---|---|---|---|---|---|---|
| | | | % of | Tₘ | R_{g} | tiv- |
| | | Phase | propene | [° C.] | [° C.] | ity |
| a) | 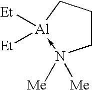 | crystalline amorphous | 10 45 | 123 — | —−50 | 630 100 |
| b) | 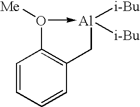 | crystalline amorphous | 5 37 | 120 — | —−65 | 170 40 |
| c) | 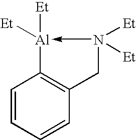 | crystalline | 10 | 123 | — | 350 |
| d) | AlEt₃ | crystalline | 7 | 122 | — | 55 |
| | | amorphous | 37 | — | −68 | 110 |

The annex (FIG. 1) contains ¹³C-NMR spectra of the ethene-propene copolymers of Example a) with different incorporation of propene, obtained with the cocatalyst [3-(dimethylamino)propyl]diethylaluminium.

### Example 2

### Ethene/propene copolymerisation

Tₚ=60° C., ethene/propene=0.4/0.6.

Activity in [kg/(mol_{Ti}*h*mol/l)].

| | | Phase | mol % of propene | Tₘ [° C.] | T_{g} [° C.] | M_{μ}[g/mol] | Activity |
|---|---|---|---|---|---|---|---|
| a) | 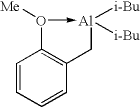 | crystalline amorphous | 4 32 | 117 — | —−69 | 1,200,000 130,000 | 400 80 |
| b) | 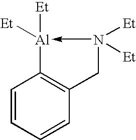 | crystalline amorphous | 13 36 | 102 — | —−51 | 410,000 160,000 | 300 280 |
| c) | AlEt₃ | crystalline | 3 | 108 | — | 1,100,000 | 75 |
| | | crystalline | 23 | 65 | — | 54,000 | 20 |

Ethene/propene=0.1/0.9.

| | | | mol % of | T_{g} | M_{μ} | |
|---|---|---|---|---|---|---|
| | | Phase | propene | [° C.] | [g/mol] | Activity |
| d) | 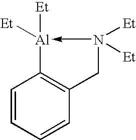 | amor- phous | 50 | −44 | 110,000 | 950 |

### Example 3

### Ethene/propene/ethylidenenorbornene terpolymerisation

Tₚ=60° C., ethene/propene/ethylidenenorbornene=0.3/0.6/0.1.

Activity in [kg/(mol_{Ti}*h*mol/l)].

| | | | | | | Ac- |
|---|---|---|---|---|---|---|
| | | | Tₘ | T_{g} | M_{μ} | tiv- |
| | | Phase | [° C.] | [° C.] | [g/mol] | ity |
| a) | 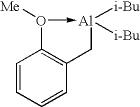 | crystalline | 116 | — | — | 65 |
| b) | 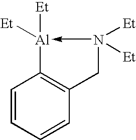 | crystalline amorphous | 93 — | —−53 | —100,000 | 80 55 |
| c) | AlEt₃ | crystalline | 122 | — | — | 55 |

The composition of the amorphous phase of the terpolymer obtained with the cocatalyst [2-(diethylaminomethyl)phen-1-yl]diethylaluminium is xₑₜₕₑₙₑ=75, xₚᵣₒₚₑₙₑ=20, x_{ethylidenenorbornene}=5.

1. Process for the preparation of co- or terpolymers from olefins, characterised in that compounds of the general formula (I) 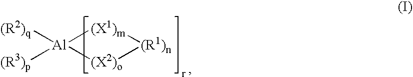
in which
X¹ denotes NR, PR, O or S, optionally complex-bonded to aluminium
X² denotes NRR′, PRR′, OR, SR, complex-bonded to aluminium
R¹ denotes linear or branched alkylene, cycloalkylidene, alkenylene, arylene, silylene, all of which may contain hetero atoms, such as N, P, O, S, F or X¹ or X², optionally complex-bonded to aluminium
R², R³, independently of one another, denote linear or branched alkyl, cycloalkyl, alkenyl, aryl, alkynyl, silyl, H, F, Cl, Br, I or X², each of which may itself be partially fluorinated or perfluorinated
R, R′, independently of one another, denote linear or branched alkyl, cycloalkyl, alkenyl, aryl, alkynyl, silyl or H, each of which may itself be partially fluorinated or perfluorinated
m denotes 0, 1
n denotes 1, 2, 3, 4, 5, 6, 7; if n>1, R¹ may, independently of one another, adopt different meanings
o denotes 0, 1
p, q denote 0, 1, 2
r denotes 3-p-q,
are used as components or cocatalysts (A) in coordination catalyst systems, where the latter in turn consist of (A), (B) a titanium- or vanadium-containing mixed catalyst and optionally (C) a support based on MgCl₂ or SiO₂ or SiO₂ in combination with MgCl₂.

2. Process according to claim 1, characterised in that the polymerisation reactions are carried out as mass or bulk polymerisations in which monomers are used as solvent, solution polymerisations in a suitable solvent, suspension polymerisations in a suitable inactive solvent or as gas-phase polymerisations.

3. Process according to claim 1, characterised in that components (A), (B) and optionally (C) are, for assembly of the coordination catalyst systems, dissolved or suspended, before their use in the polymerisation reaction, in an inert hydrocarbon, such as propane, butane, pentane, hexane, octane, decane, cyclic hydrocarbon, such as cyclopentane, cyclohexane, methylcyclopentane, aromatic hydrocarbon, such as benzene, toluene or xylene, a halogenated hydrocarbon, such as ethylene chloride, chlorobenzene or dichloromethane, or mixtures thereof as solvent.

4. Process according to claim 1, characterised in that the polymerisation reaction is carried out as solution polymerisation, where an aromatic hydrocarbon, such as benzene, toluene, xylene or ethylbenzene, or a cyclic hydrocarbon, such as cyclopentane or methylcyclohexane or an aliphatic hydrocarbon, such as pentane, hexane, heptane, or octane, or a halogenated hydrocarbons, such as chloroform or dichloromethane, or mixtures thereof or a monomer are employed as solvent.

5. Process according to claim 1, characterised in that the co- or terpolymerisation is carried out at a temperature in the range from −20 to 120° C. at a pressure in the range from atmospheric pressure to 6 bar.

6. Process according to claim 1, characterised in that the co- or terpolymerisation is carried out at a temperature in the range from 0 to 100° C.

7. Process according to claim 1, characterised in that the olefins used are at least two olefinically unsaturated hydrocarbons selected from the group ethylene, C₃- to C₁₂-alk-1-enes, such as propene, 1-butene, isobutene, 1-pentene, 4-methyl-1-pentene, 1-hexene, 1-heptene, 1-octene, 1-nonene, 1-decene, 1-undecene, 1-dodecene, furthermore styrene, α-methylstyrene, cycloolefins, such as cyclopentene, norbornene, dienes, such as 1,3-butadiene, 1,4-hexadiene, ethylidenenorbornene or norbornadiene.

8. Process according to claim 1, characterised in that the olefins used are at least two olefinically unsaturated hydrocarbons selected from the group ethylene, propylene, 1-butene, 1-hexene, 1-octene, norbornene, butadiene and ethylidenenorbornene.

9. Process according to claim 1, characterised in that the olefins used for the copolymerisation are ethene and propene or ethene and hexene or ethene and octene.

10. Process according to claim 1, characterised in that the olefins used for the terpolymerisation are ethene, propene and ethylidenenorbornene.

11. Process according to claim 1, characterised in that compounds selected from the group
[3-(dimethylamino)propyl]dimethylaluminium,
[3-(dimethylamino)propyl]diethylaluminium,
[3-(dimethylamino)propyl]dibutylaluminium,
[3-(diethylamino)propyl]dimethylaluminium,
[3-(diethylamino)propyl]diethylaluminium,
[3-(diethylamino)propyl]dibutylaluminium,
[4-(dimethylamino)butyl]dimethylaluminium
[4-(dimethylamino)butyl]diethylaluminium
[4-(dimethylamino)butyl]dibutylaluminium
[4-(diethylamino)butyl]dimethylaluminium
[4-(diethylamino)butyl]diethylaluminium
[4-(diethylamino)butyl]dibutylaluminium
[2-(dimethylamino)phen-1-yl]dimethylaluminium,
[2-(dimethylamino)phen-1-yl]diethylaluminium,
[2-(dimethylamino)phen-1-yl]dibutylaluminium,
[2-(diethylamino)phen-1-yl]dimethylaluminium,
[2-(diethylamino)phen-1-yl]diethylaluminium,
[2-(diethylamino)phen-1-yl]dibutylaluminium,
[2-(dimethylamino)benzyl]dimethylaluminium,
[2-(dimethylamino)benzyl]diethylaluminium,
[2-(dimethylamino)benzyl]dibutylaluminium,
[2-(diethylamino)benzyl]dimethylaluminium,
[2-(diethylamino)benzyl]diethylaluminium,
[2-(diethylamino)benzyl]dibutylaluminium,
[2-(dimethylaminomethyl)phen-1-yl]dimethylaluminium,
[2-(dimethylaminomethyl)phen-1-yl]diethylaluminium,
[2-(dimethylaminomethyl)phen-1-yl]dibutylaluminium,
[2-(diethylaminomethyl)phen-1-yl]dimethylaluminium,
[2-(diethylaminomethyl)phen-1-yl]diethylaluminium,
[2-(diethylaminomethyl)phen-1-yl]dibutylaluminium,
[8-(dimethylamino)naphth-1-yl]dimethylaluminium,
[8-(dimethylamino)naphth-1-yl]diethylaluminium,
[8-(dimethylamino)naphth-1-yl]dibutylaluminium,
[3-(methoxy)propyl]dimethylaluminium,
[3-(methoxy)propyl]diethylaluminium,
[3-(methoxy)propyl]dibutylaluminium,
[3-(ethoxy)propyl]dimethylaluminium,
[3-(ethoxy)propyl]diethylaluminium,
[3-(ethoxy)propyl]dibutylaluminium,
[3-(butoxy)propyl]dimethylaluminium,
[3-(butoxy)propyl]diethylaluminium,
[3-(butoxy)propyl]dibutylaluminium,
[2-(methoxy)phen-1-yl]dimethylaluminium,
[2-(methoxy)phen-1-yl]diethylaluminium,
[2-(methoxy)phen-1-yl]dibutylaluminium,
[2-(methoxy)benzyl]dimethylaluminium,
[2-(methoxy)benzyl]diethylaluminium,
[2-(methoxy)benzyl]dibutylaluminium,
[2-(methoxymethyl)phen-1-yl]dimethylaluminium,
[2-(methoxymethyl)phen-1-yl]diethylaluminium,
[2-(methoxymethyl)phen-1-yl]dibutylaluminium,
[8-(methoxy)naphth-1-yl]dimethylaluminium,
[8-(methoxy)naphth-1-yl]diethylaluminium,
[8-(methoxy)naphth-1-yl]dibutylaluminium,
[8-(ethoxy)naphth-1-yl]dimethylaluminium,
[8-(ethoxy)naphth-1-yl]diethylaluminium and
[8-(ethoxy)naphth-1-yl]dibutylaluminium are used as components or cocatalysts in coordination catalyst systems.

12. Process according to claim 1, characterised in that compounds selected from the group
[2-(methoxy)benzyl]dibutylaluminium,
[3-(dimethylamino)propyl]dimethylaluminium,
[3-(dimethylamino)propyl]diethylaluminium and
[2-(diethylaminomethyl)phen-1-yl]diethylaluminium are used as components in coordination catalyst systems for the co- and terpolymerisation of olefins.

13. Process according to claim 1, characterised in that compounds selected from the group
[2-(methoxy)benzyl]dibutylaluminium,
[3-(dimethylamino)propyl]diethylaluminium and
[2-(diethylaminomethyl)phen-1-yl]diethylaluminium are used as compounds in coordination catalyst systems for the copolymerisation of ethene with propene.

14. Process according to claim 1, characterised in that
[3-(dimethylamino)propyl]dimethylaluminium are used as components in coordination catalyst systems for the copolymerisation of ethene with hexene.

15. Process according to claim 1, characterised in that
[2-(diethylaminomethyl)phen-1-yl]diethylaluminium is used as component in coordination catalysts for the terpolymerisation of ethylene, propylene and ethylidenenorbornene.

16. Ethylene-propene copolymer having a molecular weight in the range from 50,000 to 1,500,000 g/mol, obtainable by a process according to claim 1.

17. Ethylene-propene copolymer according to claim 16, having a molar ethylene/propene ratio of 1:99 to 99:1.

18. Ethylene-propene copolymer having a molar ethylene/propene ratio of 50:50 and a molecular weight in the range from 100,000 to 200,000 g/mol, obtainable by a process according to claim 1.

19. Ethylene-propene-ethylidenenorbornene terpolymer having an ethylene/propene/ethylidenenorbornene ratio of x_{ethylene}:0.5-0.9, x_{propylene}:0.05-0.3, x_{ethylidenenorbornene}:0.05 0.2 mol, a molecular weight in the range from 50,000 to 1,000,000 g/mol, obtainable by a process according to claim 1.

20. Ethylene-propene-ethylidenenorbornene terpolymer having an ethylene/propene/ethylidenenorbornene ratio of x_{ethylene}:0.75, x_{propylene}:0.2, x_{ethylidenenorbornene}:0.05 mol, a molecular weight of 100,000 g/mol and a glass transition temperature of T_{g}=−53° C., obtainable by a process according to claim 1.
